(19) United States
(12) Patent Application Publication
(10) Pub. No.: US 2024/0116307 A1
(43) Pub. Date: Apr. 11, 2024

(54) METHOD PROVIDING A WORKPIECE WITH A THREE-DIMENSIONALLY TEXTURED SURFACE COATING

(71) Applicant: Giorgio MACOR, Villorba (IT)

(72) Inventor: Giorgio MACOR, Villorba (IT)

(21) Appl. No.: 18/270,180

(22) PCT Filed: Dec. 28, 2021
(86) PCT No.: PCT/IT2021/050437

§ 371 Date: Jun. 28, 2023

(30) Foreign Application Priority Data
Dec. 29, 2020 (IT) 102020000032476
Apr. 1, 2021 (IT) 102021000008192

(51) Int. Cl. B44C 1/17; B41M 5/00; B41M 5/025; B44C 3/02; E04F 15/10

(52) U.S. Cl. CPC B44C 1/1733; B41M 5/0047; B41M 5/0058; B41M 5/0064; B41M 5/0256; B44C 3/025; E04F 15/107; B41M 2205/10; E04F 15/02038

(57) ABSTRACT

The present invention refers to a method for decorating a material comprising the steps of: applying a three-dimensional layer (110) by inkjet printing on at least a part of a support (100). Apply one or more of the following layers on at least a part of the support on which the three-dimensional layer has been created: release layer, texturing layer (120), decorative layer (130), white layer (140), colored layer, functional layer, adhesive layer (150). Apply the transferable decoration on at least part of a material (160) to be decorated. Remove the support (100). Reveal the 3D.

### FIELD OF APPLICATION

The present invention is part of the technical sector of materials and methods for decorating and generating texturing on surfaces on materials such as for example panels for the production of flooring, coverings, furnishings and more generally surfaces for architecture and design.

The present invention exploits the combination of both the properties of traditional technologies, which offer high mechanical, chemical-physical properties, low costs and the versatility of digital technology which allows total customization and short runs.

The present invention relates to a process for making transferable decorations and in particular a transferable decoration obtained by means of this process.

The process and the transferable decoration, object of the present invention, might be used for the realization of decorations to be transferred, preferably cold transfer, on surfaces of any type, both smooth and rough (such as wood, glass, metal, plastic, plaster, etc.) and in particular for interior architecture such as flooring, wall coverings, furniture, skirting boards, doors and window frames.

The process and the transferable decoration, object of the present invention, allows to obtain a surface decorated as if it had been coated and finished in the traditional way.

### STATE OF ART

Digital printing and in particular inkjet printing is fast growing in industrial sectors, replacing traditional methods based on analogue printing. The advantages of digital printing are considerable and include high flexibility, the ability to produce short runs and the reduction of consumable waste.

In particular, the reproduction of wood on various materials represents a typical application of digital printing for the production of flooring, furniture, skirting boards, profiles and in general in the field of design and architecture.

For this application, the material consists of wood and derivatives (MDF/HDF/Particleboard/plywood), plastics (PVC/polyolefins), metals, on which the image is printed and finished to increase its resistance to abrasion and scratches.

In particular in the case of flooring and panels for furniture, the finishing after printing might involve the use of a layer of melamine resin (laminates) or a coating applied with the normal techniques in use (roller/spray/curtain/die). The coating can be of various kinds such as radiation-curable, epoxy, polyurethane, hot-melt and can contain water and/or solvents to control its viscosity.

In the reproduction of natural materials such as woods and stones, in order to obtain a material more similar to the original even in the touch, in addition to the image it is also necessary to reproduce the surface structure.

Embossing is normally performed on the surface layer and can be obtained with various methods such as pressing with molds, rollers or films on which the structure to be imprinted is reproduced. The process can take place by pressure on resins that are not totally hardened, on thermoplastic materials, on radiation-curable resins with simultaneous irradiation and polymerization.

Still with the aim of faithfully reproducing natural materials, a desired feature is to have the embossed structure in register with the printed image or to obtain correspondence between concavity/convexity and the printed image. With traditional processes, register embossing (better known as EIR: Embossing In Registration) is not easy to obtain, both for the necessary precision and for the need to have multiple molds corresponding to the various structures to be printed with the corresponding image.

Even more so with digital printing that allows you to easily produce different images, a method of obtaining the surface structure in a simple and efficient way would be appropriate.

In fact, the modern scanners used to acquire the image of materials, for example METIS DRS 2000, also allow the simultaneous acquisition of the surface structure which can be advantageously used for register embossing.

In the past, various technologies have been proposed that provide for the decoration and formation of surface structures using direct printing on the material to be decorated using inkjet technology:

The patents EP2108524B1 and EP2507063 provide for the use of a UV formulation to generate 3D structures in order to imitate the grain of the wood.

Patent EP3109056 provides for the use of a UV formulation applied by inkjet printing on an uncured UV coating to generate 3D structures in order to imitate the grain of the wood.

The patent WO2020039361A1 provides for direct printing and the creation of 3D structures, in order to imitate the grain of the wood, by removing material.

The technologies described above, while providing 3D decoration and structure using digital technology, cannot be used for printing a finished floor plank and cannot be used for the decoration of 3D profiles, with planes contiguous to each other.

To simplify the logistic and to further short the time to market, the market is aiming to decorate the finished product. Particularly, it would be appropriate to decorate the finished flooring planks already profiled.

It is therefore desirable to identify new methods of decoration and embossing of the surfaces of the objects, which are quick, simple to apply in register on surfaces of different materials, as well as with low costs.

### Definitions

Embossing (texturing): creation of superficial texture
Texturing (embossing): creation of superficial texture
Radiation-curable (photocurable): means that the layer is curable by UV radiation and/or by e-beam (electron beam)
Photocurable (radiation-curable): means that the layer is curable by UV radiation and/or by e-beam (electron beam)
3D: three dimensional
Texture or three-dimensional structure: a combination of recesses and protrusion according to a predetermined pattern defining dimensions area and depth or height of the said recesses and protrusions and/or relative position of the said recesses and protrusions along a surface of a layer to which the said texture or the said threedimensonal structure is applied
3D layer: a layer having a certain thickness and having a certain length and width and a surface to which a texture or a three-dimensional structure according to the above definitions has been applied.
The texturing layer: the layer which becomes three-dimensional by means of the process object of the invention.
Adhesive: any substance that is capable of holding materials together in a functional manner by surface attachment that resists separation

### BRIEF DESCRIPTION OF THE INVENTION

In accordance with an aspect of the invention, the Applicant has found a method for decorating a material by means of combining digital printing technology and analogue technology.

The present invention is particularly suitable for decorating 3D profiles which can hardly be printed directly. Such profiles are for example finished flooring planks, skirting boards, door and window profiles.

In the case of digital decoration, the 3D profiles are generally decorated by applying a plastic or paper film printed by inkjet printing on the surface which is subsequently finished with a coating suitable to protect the print. The application is normally carried out with the use of a glue, generally of the hotmelt type. The high thickness of the film requires a high weight of adhesive (60-90 g/m2) which then makes it difficult to trim the film after application.

If the adhesive were printed using inkjet printing, its quantity could be reduced, applying it in a different way with larger quantities where the mechanical stress is higher, such as on the radius of the profile.

The process and the transferable decoration, object of the present invention, reduces the total thickness of the various layers to be transferred, reducing the weight of adhesive necessary for the application.

The transfer object of the invention is made of layers created on demand and no other polymer film is part of it.

Advantageously, the reduction of the total thickness of the decorative package makes the decoration more natural and less plastic.

Additionally, because the transfer weight is lighter than traditional decorating films made of PVC or paper, the product is environmentally more sustainable.

The flooring market is looking to decorate in single plank mode. Most of the finished planks have a mechanical interlocking (locking, click) for coupling them during installation. Said profile is present on all four sides of the plank and is generally produced by profiling machines after the decoration and cutting of the panels. During profiling, a chamfer (bevel) is normally generated which is usually colored to make it homogeneous with the color of the plank surface.

Another issue for the decoration of finished flooring is the application of protective coating which, being applied at high weights, typically 80-250 g/m², tends to dirty the bevel, the interlocking system and create the typical creasing effect in proximity of the edges due to the abundance of coating.

It would therefore be desirable to find a solution capable of decorating a finished floor plank avoiding the problems mentioned above.

### DETAILED DESCRIPTION OF THE INVENTION

The method object of the invention provides a workpiece with a three-dimensionally textured surface coating at least on part of its surface the method consisting in using a transferable decoration for providing the said coating.

According to a more general combination of steps the method according to the present invention providing a workpiece with a three-dimensionally textured surface coating at least on part of its surface consists in using a transferable decoration for providing the said coating comprises the following steps:
a) Create a three-dimensional layer by inkjet printing on at least part of a support.
b) Apply one or more of the following layers on at least part of the support:
i) Release layer
ii) Texturing layer
iii) Decorative layer
iv) Functional layer
v) White layer
vi) Colored layer
vii) Adhesive layer
c) Apply the transferable decoration on at least part of a material to be decorated.
d) Remove the support.
e) Reveal the 3D texture

According to a first alternative, the method for providing a workpiece with a three-dimensionally textured surface coating at least on part of its surface by using a transferable decoration, the method consisting in the following phases:
a) Create a three-dimensionally structured shaping layer by inkjet printing on at least part of a support by
b) Applying one or more of the following additional layers on at least part of the shaping layer, the said layers being applied one on top of the other according to the following order:
   i) Optionally a release layer
   ii) A texturing layer, the said texturing layer being three-dimensionally shaped by the said three-dimensionally structured shaping layer showing a complementary surface structure in relation to the said three-dimensionally structured layer
   iii) A Decorative layer
   iv) Optionally a Functional layer
   v) An adhesive layer
c) Applying the transferable decoration on at least part of a workpiece to be decorated, the said workpiece having an external surface and the said transferable decoration being applied by bringing the said transferable decoration with the said adhesive layer in contact with at least part of the surface of the said workpiece;
d) Removing the support with the three-dimensionally structured shaping layer and the optional release layer;
e) Revealing thereby the texturing layer which is provided with the said surface structure complementary in relation to the said three-dimensionally structured shaping layer;
f) Optionally recovering and storing the said support and/or the said three-dimensionally structured shaping layer.

According to a second alternative, the method for providing a workpiece with a three-dimensionally textured surface coating at least on part of its surface by using a transferable decoration, the method consisting in the following phases:
a) Create a three-dimensionally structured shaping layer by inkjet printing on a temporary carrying support, the said temporary carrying support not being part of the said transferable decoration at the time of application of the transfer decoration to the workpiece;
b) Applying one or more of the following layers on the said three-dimensionally structured shaping layer according to step a), the said layers being applied one on top of the other according to the following order:
   i) Optionally a release layer
   ii) A texturing layer, the said texturing layer being three-dimensionally shaped by the said three-dimensionally structured shaping layer showing a complementary surface structure in relation to the said three-dimensionally structured layer
   iii) A Decorative layer
   iv) Optionally a Functional layer
   v) An adhesive layer
c) Applying the transferable decoration on at least part of a workpiece to be decorated, the said workpiece having an external surface and the said transferable decoration being applied by bringing the said transferable decoration with the said adhesive layer in contact with at least part of the surface of the said workpiece;
d) Removing the said three-dimensionally structured shaping layer and the optional release layer;
e) Revealing thereby the texturing layer which is provided with the said surface structure complementary in relation to the said three-dimensionally structured layer.

As it will appear with more detail in the following the difference between the said two alternatives resides in the fact that in the first alternative a support for the three-dimensionally structured shaping layer is generated by inkjet printing on a support which support is temporarily part of the combination of layers forming the transfer decoration and is separated from the said combination of layers after adhesion onto the workpiece together with the said the three-dimensionally structured shaping layer. Therefore, the process generates waste material, namely the support and the three-dimensionally structured shaping layer adhering to it which needs to be recovered.

According to a possible improvement of the said first alternative, the said support together with the said shaping layer can be stored and reused for producing further three-dimensional transfer decorations. Also a closed loop process can be provided in which the said support together with the said shaping layer can be stored and reused for producing further three-dimensional transfer decorations.

According to a variant embodiment the support may be cleaned from the three-dimensionally structured shaping layer and reused as support in a further different process for producing and applying a transfer decoration according to the first alternative described above.

In the second alternative, no such support is provided but simply a sort of temporary tray is used for allowing that the process for producing the three-dimensionally structured shaping layer is carried out. In this case this layer is at the same time the supporting layer for the combination of the one or more additional layers which combination is then transferred without the said tray onto the surface of the workpiece. In this case, there is no support to be recovered.

In both the above alternatives the process is carried out by using a so-called reversing technique of the staple of layers forming the decorative layer, since the order of the layers disclosed above is the inverse one as the order of layers after the combination of layers forming the transfer decoration is applied to the workpiece.

The two alternatives disclosed above are preferably dedicated to a process of creating the three-dimensionally structured shaping layer by additive printing and specifically by additive inkjet printing. This means that the pattern of recesses and reliefs providing the surface texture of the coating are obtained by depositing the ink with different thickness at different points or zones of the surface.

According to a further optional embodiment of each of the two alternatives, a layer of white color is applied alternatively before the layer of adhesive in the combination of layers forming the transfer decoration or on the workpiece at the surface at which the transfer decoration has to be applied.

According to still a further optional embodiment, a colored layer is applied on top of the white layer or alternatively to the white layer.

According to a variant embodiment, the adhesive layer may be applied on the surface of the workpiece and, when provided on it, on top of the white layer and/or of the colored layer and the step c) of each of the above disclosed alternatives is carried out by adhering the surface of the support opposite to the three-dimensionally structured shaping layer or the surface of the three-dimensionally structures shaping layer opposite to the texturing layer on the exposed surface of the adhesive layer previously applied to the workpiece.

According to the third alternative, the method for providing a workpiece with a three-dimensionally textured surface coating at least on part of its surface by using a transferable decoration, consists in the following phases:
a) Create a three-dimensional structured shaping layer by applying one or more of the following layers on a temporary support the said layers being applied one on top of the other according to the following order:
   i) A first white layer;
   ii) Optionally a decorative layer;
   iii) A texturing layer;
   iv) A fluid for three-dimensionally shaping the texturing layer which is applied on top of the said texturing layer by covering first areas and leaving uncovered second areas according to a predetermined pattern reproducing the pattern of the three-dimensional structure of the three-dimensionally structured coating;
b) Applying an adhesive layer to the surface of a workpiece in the partes of the said surface at which the three-dimensionally textured coating has to be applied;
c) Applying the transferable decoration on the said parts of a workpiece to be decorated, by bringing the surface of the white layer opposite to the decorative layer and/or opposite to the texturing layer in contact with the exposed surface of the said adhesive layer.
d) Revealing the three-dimensional structure of the texturing layer by removing the fluid for the three-dimensional shaping at least at some of the areas covered by the said fluid or removing at least partly for a certain depth the material of the texturing layer at least at some of the areas of the texturing layer not covered by the said fluid.

In relation to the three-dimensional shaping phase of the texturing layer the technologies disclosed according to WO2020039361A1 and/or WO2021214659A1 or variations thereof may be applied.

According to the more general definition of the above-mentioned technologies the three-dimensional shaping of the surface of the texturing layer is generated by the following combination of steps:
applying a texturing layer made of a resin A, or a paint or ink containing it, on the surface of a substrate thus forming a coating;
applying a liquid B at least on a portion of the texturing layer when said texturing layer is still liquid or partially solidified;
irradiating for modifying the physical/chemical status of the mixture of material of the texturing layer and the liquid B or of only the material of the texturing layer at the zones not covered by the liquid B or of the sole liquid B;
d. removing the material of the texturing layer at the zones not covered by the liquid B and/or of the mixtures of the liquid and the material of the texturing layer at the zones covered by the liquid B or only of the liquid B.
depending on the chemical/physical nature or composition of the material forming the texturing layer and/or of the liquid B the removal may be carried out by using several different techniques or combinations of one or more thereof such as mechanical removal by brushing and/or sanding and/or by exposing to air and/or liquid jets and/or by solution in a solvent and/or by washing.

In relation to each of the above disclosed three alternative embodiments, the further steps may be applied of applying on top of the exposed surface of the three-dimensionally structured coating applied to the workpiece, one or more finishing layers. The transfer decoration object of the invention can be used to decorate rigid or flexible materials of various kinds such as, for example, woods and derivatives (e.g. MDF/HDF, chipboard, osb), laminates and melamine, plastics of various kinds (e.g. PVC, PP, PE, PET), glass, metals, wall surfaces, natural or synthetic leather, fabrics. The materials can be flat or three-dimensional, such as profiles for skirting boards or for window/door frame. The transfer decoration can be applied by calendering, by means of rollers in the case of 3D profiles but it could also be applied manually.

In one form of the invention, some layers might applied directly to the substrate to be decorated.

The layers can be applied in different order than listed above. Furthermore, depending on the aesthetics and functionality of the decoration, all or only a part of the layers object of the method of the invention might be applied.

In principle, all the layers that make up the transfer can be applied by inkjet printing.

Alternatively, traditional application technologies such as rotogravure, flexography, roller and curtain coaters might be used.

In a preferred aspect of the invention, the use of slot-dies is particularly suitable, which allows to easily dose the applied quantity and to modulate the application width by means of the use of shims.

Typically, the layers can be of various chemical nature such as, for example, but not limited to a polyurethane, epoxy, acrylate, acrylic system and combinations thereof.

Preferably the layers are made up of 100% solid in order to avoid the solvent and/or water evaporation operations.

In a preferred form of the invention, the layers are of a radiation-curable nature, a technology widely described in the text “Radiation Curing: Science and Technology” (Pappas).

Radiation-curable resins are polymerizing when irradiated by ultraviolet ray devices and/or by irradiation with EB (Electron Beam) and are divided into two types based on the crosslinking mechanism:
1) radicalic, typically from vinyl monomers and acrylate resins which are divided into several sub-categories: epoxy-acrylate, urethane-acrylate, polyester-acrylate, polyether-acrylate, amino-acrylate, silicon-acrylate, polyisopren-acrylate, polybutadien acrylate and monomers acrylates. Among the vinyl monomers we can mention N-vinyl caprolactam (NVC), acryloyl morpholine (ACMO), diethylene glycol divinyl ether (DVE-2), triethylene glycol divinyl ether (DVE-3) and their mixtures.

The term acrylate refers to both acrylate and methacrylate resins.
2) cationic resins such as epoxies, polyols and monomers such as oxetanes and vinyl ethers.

Typically, radiation curing by UV irradiation can be carried out with one or more Hg lamps and/or with LED lamps.

In a preferred embodiment of the invention, LED lamps are used to carry out the method of the invention, characterized by lower consumption, longer life and lower heat emission compared to traditional Hg lamps.

Inkjet

Inkjet printing can be either in multipass/scanning mode where the image is generated with multiple passes of the printhead while the material to be printed advances or in singlepass mode, where the material to be printed passes only once under the printheads which are installed at the same width of the material to be decorated. Single-pass printing is used for large runs (>1000 m²/h) while multipass printing is used for small and medium runs (10-600 m²/h), is certainly the most common.

Typically inkjet printing involves the use of a printhead to create and jet droplets of inks which will then form the image to be printed. As an example, details of this type of printing can be found in the book “Fundamentals of inkjet printing: the science of inkjet and droplets” (Hoath, Stephen).

Depending on the printhead used, the droplets produced can have different diameter and consequently different volume.

In addition to the native droplet size, an intrinsic characteristic of the printhead, larger droplets can be generated by the printhead itself. For example, a printhead capable of jetting 4 levels of gray will have the smallest drop of 6 μl while the largest will be 18 μl.

Support

In one aspect of the invention according to the above disclosed first alternative, a support is used for transferring the layers applied thereto onto the material to be decorated.

In one aspect of the invention the support is used only once and after having transferred the desired layers, it is rewound and destined for recycling. In this case the 3D structure might stay adhered to the support.

In a preferred form of the invention the support is flexible and can consist of synthetic polymers such as for example BOPP, PP, PET, PE, PVC; natural polymers such as cellulose, paper and their combinations. In order to keep costs down, the support has a thickness between 12μ and 100μ. Lower thicknesses are more complex to manage in the machine, especially at high speeds, while higher thicknesses may be inconvenient, especially if the film is used only once. Obviously, different thicknesses might be used to meet specific needs.

In another aspect of the invention the support is according to the second alternative embodiment disclosed above ad is in the form of a temporary support not being part of the combination of layers forming the transfer decoration to be applied to the workpiece. In this case the support is used continuously and does not represent a waste layer as in the embodiment according to the first alternative. All the layers, including the 3D one, are transferred to the material to be decorated except the temporary support. In this way the support can be reused to repeat the operation indefinitely. For this application, the support is preferably made of a mechanically resistant material consisting of but not limited to rubber such as silicone rubber, FKM, EPDM and polymers like polyimide, polyamide, PTFE, metals with a thickness between 0.5 mm and 5 mm.

In another form of the invention the support is rigid and is used as if it were a mold which transfers the decoration by pressing it onto the material to be decorated.

To obtain different gloss level, the support can be superficially finished with different gloss which will then be transferred to the first layer applied to the support. For example, if the support had gloss 8 (60°) and the first layer was the texturing layer, once transferred this would have the same gloss 8 (60°).

3D Layer

The texture is preferably generated by inkjet printing with the advantage of easily obtaining registration with the underlying image.

Additive 3D Shaping

In a first aspect of the invention the 3D layer is generated by superimposing multiple layers printed by inkjet. For convenience this method of generating a three-dimensionality of a shaping layer will be called “ADDITIVE 3D”.

Direct 3D Shaping

In a preferred embodiment according to the third alternative of the invention disclosed above, the technology described in the patent WO2020039361A1 and or WO2021214659A1 might be used, where the texture is generated by inkjet printing a specific liquid on a liquid coating. The whole is then solidified/polymerized and the three-dimensionality is generated by removing the areas where the liquid has previously been printed. For convenience this method of generating a three-dimensionality will be called “DIRECT 3D”.

In the event that the ADDITIVE 3D shaping layer and/or a texturing layer to which a shaping fluid is applied according to the above-described DIRECT 3D technology is transferred together with the other layers, in order to obtain the 3D structured coating of the workpiece, the 3D shaping fluid applied to the texturing layer or the three dimensionally structured shaping layer must be removed (<FIG. 2.7, FIG. 4.7, FIG. 7.8). The 3D structured shaping layer or the 3D shaping fluid layer is formulated in order to obtain a softer/more fragile material than the texturing layer in which the 3D structure will be generated. In general, the Tg of the 3D layer structured shaping layer or of the 3D shaping fluid layer must be lower than the Tg of the texturing layer, facilitating its removal.

Preferably, the removal of the 3D layer structured shaping layer or of the 3D shaping fluid layer will be of the mechanical type and can therefore be carried out with the same machinery used for wood brushing. These machines use brushes and/or pads made of more or less aggressive materials (steel, brass, nylon fibers, polyester fibers) depending on the hardness of the material to be removed and the desired degree of finish The equipment described above are for example produced by CEFLA (eg RSP4) and QUICKWOOD (eg CDI/300+LEV).

The removal of the 3D layer structured shaping layer or the 3D shaping fluid layer can also be carried out by means of a jet of air with high pressure or by a jet of water with high pressure.

In a further form of the invention, the 3D layer can be removed with the use of a roller or adhesive tape which can then be cleaned and reused again.

In a further form of the invention the 3D layer structured shaping layer or the 3D shaping fluid layer can be removed using a suitable solvent.

In another form of the invention the 3D layer structured shaping layer or the 3D shaping fluid layer is water soluble and can be removed by immersion in water or by means of a water jet.

In case of ADDITIVE 3D, the depth of the three-dimensionality created in the texturing layer is a function of the thickness of the 3D layer structured shaping layer and of the layer subsequently applied to the 3D structured shaping layer.

In case of a DIRECT 3D technology for three-dimensionally structuring the texturing layer, the depth of the three-dimensionality created in the texturing layer is a function of the thickness of the 3D shaping fluid layer and of the layer subsequently applied to the said 3D shaping fluid layer.

In another embodiment of the invention, the 3D texture is generated by combining ADDITIVE 3D and DIRECT 3D techniques according to the above embodiments and variants.

Texturing Layer
The texturing layer is the layer which becomes three-dimensional by means of the process object of the invention.

In a preferred embodiment of the invention, the texturing layer is a protective layer.

The protective layer is applied (typically 20-200 g/m²), its function is to protect the decorative layer from abrasion and wearing. The protective layer may contain anti-abrasive materials to increase its resistance to abrasion. Abrasion resistance depends on the chemical composition of the coating itself, on the presence of anti-abrasive particles, such as aluminum oxide and on the thickness applied.

Decorative Layer

The decorative layer is preferably applied by inkjet printing and generates the decorative image but could also form a solid color.

The ink for making the decorative layer is preferably of a radiation-curable nature, commonly called UV ink, but it could also be water-based, solvent-based or a combination of the various technologies (hybrid ink).

Normally printing involves the use of four-color process, such as cyan, magenta, yellow and black or six-color where in addition to the main colors, the corresponding lights are used, such as light cyan, light magenta, light red and light black.

In a preferred form of the invention, the pigments are selected so as to minimize the effect of metamerism. In particular, the pigments that make up the yellow component and those that make up the red component are mainly responsible for metamerism. The use of red instead of magenta can reduce the metamerism of the red component. In order to further reduce this phenomenon, the writer has found that by combining the classic four-color/six-color process with brown tints, it can further reduce the metamerism. In addition to brown organic pigments such as PBr 25 and PBr 41, inorganic pigments can be used, the same ones used for inkjet decoration of ceramics.

Advantageously, the use of the technology object of the invention could be used with specific colors to produce light, medium, dark, desaturated and gray woods. For example, the printer could be set up to print gray or heavily desaturated wood using 2 or more levels of gray (e.g. light black and light light black) in addition to black and lights colors like Lm, Lc, Lr.

Customers not only require that their documents (images) are accurately reproduced in color, but also demand that the outputs do not vary over time. Color consistency, over time is often achieved or maintained by calibration. Most of the existing printer calibration methods are template based—meaning that they require the printer to print a set of test templates. The actual outputs are then measured and compared with the desired outputs to generate the error signal that drives the calibration process. The template-based approach is typically “offline” and “discrete” in nature. Thus, such an approach requires stopping the normal printing process. While this might not be particularly disturbing for short runs, where the calibration might be scheduled between print jobs, it is certainly an inconvenience and an impact to efficiency when a long run print job needs to be interrupted for calibration. Also, off-line calibration is a “discrete” event, meaning there is typically a significant time interval between two consecutive calibrations, where appreciable color error may accumulate during the period between calibrations.

In a preferred form of the invention, the transfer system is equipped with in-line color measurement capable of feedback the color and adjust the color accordingly.

White Layer

Consistency in color reproduction is one of the main limitations of inkjet printing. The white layer is used to uniform the color of the base and to bring out the decorative layer. The amount of white base generally varies between 10 g/m² and 50 g/m², depending on the background color of the material to be decorated and the desired white point.

In another form of the invention, the white base could be made by applying a white film to the material to be decorated. This operation is commonly used for SPC, on which a white PVC film is laminated on the core.

Colored Layer

The colored layer can be applied in order to reduce ink consumption and homogenize the background. The color can be applied already formulated or it can be created online by combining different colors. Multiple colored layers might be overlayed to generate the desired tint. As an example, the colored layer is generated by applying two or more superimposed color layers or colors.

In a further form of the invention, the colored layer is applied below the white layer in order to make a deep scratch/abrasion due to wear less evident. In this case, to increase the abrasion resistance, the colored layer might contain anti-abrasive fillers.

In a further form of the invention, the colored layer is applied by inkjet printing.

Adhesive Layer

Adhesives are often broken into two types, depending on how they're made. They are classified as either pressure sensitive or polymer-based, though there are also other classifications that include:
1. Anaerobic
2. Bismaleimides
3. Casein
4. Cyanoacrylate
5. Dextrin
6. Electrically conductive
7. Hot melt
8. Phenolic
9. Plastisol
10. Polyvinyl Acetate (PVA's)
11. Reactive
12. Solvent-Based
13. Thermoset
14. Radiation curable
15. Water-Based

Pressure sensitive adhesives (PSA) consist of acrylics, rubber/latex, or silicone. They don't need a solvent, water, or heat to stick and can be applied with light pressure to paper, glass, wood, plastic, or metal.

Polymer adhesives are broken up into polyester, polyurethane, acrylate, and epoxies. Polymer-based adhesives are considered the best for bonding woods, but are actually used in many other industries.

Ultimately, adhesives are classified based on whether or not they use a solvent, water, heat, or any combination of the three to stick to a surface.

Preferably the adhesive consists of a PSA (pressure sensitive adhesive) with the advantage of obtaining immediate adhesion on the material to be decorated, without using heat and high pressures which could generate mechanical/thermal stress on the previous layers causing damage/breakage.

In a further aspect of the invention, the PSA is of the dual-cure type, for example the PSA curing can take place by UV irradiation and at the same time a secondary reaction between isocyanate and hydroxyl can be activated. This type of reaction could be favored by heat.

In a further aspect of the invention, the PSA is radiation-curable and is capable of reacting distinctly to two different wavelengths, thus generating different levels of tack. This characteristic might for example be achieved with the use of reactive photoinitiators at different wavelengths, such as, for example, TPO (385-410 nm) which does not react well to shorter wavelengths (<365 nm) in a mixture with alpha-hydroxyketones which, on the other hand, have reactivity at shorter wavelengths (<365 nm) and do not react at longer wavelengths (385-410 nm). A PSA thus formulated would have a good tack when irradiated with a LED lamp (385-410 nm) and after being applied it could be irradiated with a traditional Hg lamp completing the crosslinking and obtaining structural properties.

In a preferred aspect of the invention, the PSA is applied by inkjet printing.

In another aspect of the invention, the adhesive layer is applied generating a 3D pattern capable of letting the air escape during the application of the transfer and thus minimizing the formation of air bubbles.

In a further aspect of the invention, the adhesive layer is applied in different quantities in the latitudinal and/or longitudinal direction of printing, applying larger quantities where necessary.

In a preferred aspect of the invention the adhesive layer is applied directly to the material to be decorated. In this way the transfer will adhere only to the parts of the material to be decorated where the adhesive layer has been applied, preventing it from being transferred to parts of the material where the transfer is not desired.

In another preferred form of the invention, the adhesive layer is applied both on the material to be decorated and on the transfer. In this way it will be easy to make the two layers adhering.

In a further form of the invention one or more of the layers to be transferred also possess adhesive properties. For example, the white layer and/or the patterned layer can be formulated to be PSAs rather than heat-activated formulations.

In another form of the invention, the layers can react with each other. For example, a layer could contain isocyanate groups and the next and/or previous layer can contain hydroxyl groups forming an isocyanate-type bond between the 2 layers.

Release Layer

In a further aspect of the invention a release layer is applied. This layer has the function of facilitating the detachment of the transfer, leaving the substrate material clean, ready to receive the next layer. As an example, the release layer could consist of radiation curable formulations containing silicone moiety.

Functional Layer

In a further optional aspect of the invention a functional layer is applied. This layer might be applied to impart special optical and/or physical properties like high refraction, conductivity, pearlescent effect, metal effect, thermal sensitivity, conductivity. The functional layer might be also used to produce electricity like embedding a Perovskite solar cell.

Application

The transfer might be applied using for example calenders, double belt presses, lamination lines and combination of the previous technologies or in a discontinuous way using for example flat presses and membrane presses. The layers constituting the transfer, might be produced in discrete mode (FIG. 2, FIG. 3, FIG. 4) or in alternative continuously (FIG. 7). In case of continuous application on discrete substrates, like floor planks, the transfer might be cut before the application or after the application on the material to be decorated. The transfer might be cut e.g. by using knife or water jet. In a preferred form of the invention the adhesive is already applied on the material to be decorated and when the continuous transfer is applied to it, the pressure is able to cut it leaving clean edges. Possible residues mighty be easily removed by pressurized air stream and/or brushing.

In a form of the invention, the transfer is applied directly from the support to the material to be decorated (FIG. 2, FIG. 3).

In a preferred form of the invention, the transfer is firstly applied from the support to one or more subsequent laminating tool and then applied to the material to be decorated (FIG. 4.6, FIG. 7.6).

In a preferred form of the invention, subsequently to application of the transfer on the material to be decorated, there is one or more additional laminating tool (FIG. 7.7) suited to better adhere the transfer to the material to be decorated. The laminating tool might have specific shape to better adapt to the 3D parts of the material to be decorated.

In a preferred form of the invention, the transfer has a slightly larger dimension than the material to be decorated. This abundance facilitates centering and application. The abundance is easily removed with the same machine at the same time as the removal of the 3D layer incorporated in the texturing layer.

In another form of the invention the transfer is produced on a flexible support which is rolled-up. The transfer might be then applied to the material to be decorated on dedicated equipment. To facilitate the release, it would be advisable to have one side of the flexible film with release properties or alternatively the flexible film might be coupled with silicone paper on the transfer side.

According to a further feature of the present method the workpiece is provided with a surface zone for receiving a coating having a three-dimensional structure, which surface zone has a predetermined planar shape and predetermined dimensions according to two directions spanning the plane containing the said planar shape, a step being provided providing the said combination of layers forming the transfer decoration according to anyone of the above mentioned alternative embodiments with a shape and dimensions essentially corresponding to the shape and dimensions of the said surface zone to which the said transfer decoration is to be applied.

In the case of profiles, traditional profiles wrapping machines (Barberan/Cefla) might be used.

In a preferred form of the invention, in order to obtain the desired aesthetics in terms of gloss, touch, scratch and chemical resistance, a finishing coating is applied as final layer (FIG. 2.8, FIG. 3.8, FIG. 4.8, FIG. 7.9).

In another form of the invention, the transfer consists of only a few layers. For example, only the texturing layer with or without a 3D layer might be transferred. Alternatively, only the decorative layer without the texturing layer might be transferred and the coating might be applied later.

In another form of the invention, the transfer could be manually applied to various surfaces as a decorative coating. As an example, it might be used to decorate panels for DIY (do-it-yourself).

Several additional features may be provided for the method according to one or more of the previously described embodiments and variants. The said additional features may be provided alternatively or in any combination one with the other.

According to a further feature, the layers forming the transfer decoration may be applied in different order.

In a further variant embodiment, one or more of the layers forming the transfer decoration are applied several times.

According to a further feature, the layers are constituted by radiation-curable systems.

Still according to a further variant embodiment, one or more layers in addition to their main function as release and/or texturing and/or decorative and/or white and/or colored and/or functional layer possess adhesive properties.

According to a further feature, a chemical reaction takes place between two or more layers in contact with each other.

### BRIEF DESCRIPTION OF THE DRAWINGS

FIG. 1

FIG. 1A illustrates the structure of a possible transferable decoration object of the invention made with ADDITIVE 3D technology for a three dimensionally structured shaping layer of the texturing layer.

FIG. 1B illustrates the structure of a possible transferable decoration object of the invention made using with DIRECT 3D shaping technology of the texturing layer.

FIG. 1C illustrates the removal of the support with the 3D structured shaping layer integral with the substrate itself.

FIG. 1D illustrates the removal of only the support while the 3D layer structured shaping layer remains adhering to the texturing layer

FIG. 2

FIG. 2 illustrates the process for making and applying the transfer decoration in which a transitory support is provided according to the second alternative embodiment of the present invention which can be continuously reused. The three dimensionally structured shaping layer, which may be generated by ADDITIVE 3D inkjet printing remains adhering to the texturing layer and the 3D structure of the texturing layer is revealed by material removal (2.7).

FIG. 3

FIG. 3 illustrates the process for making and applying the transfer decoration according to the first alternative embodiment of the present invention with the flexible disposable substrate and with the 3D structured shaping layer which remains integral with it when removing the substrate. In the present example the 3d structured shaping layer is generated by additive inkjet printing.

FIG. 4

FIG. 4 illustrates the process for making and applying the transfer decoration according to the third alternative embodiment of the present invention with a temporary support which can be continuously reused. The texturing layer is three-dimensionally shaped by using a direct 3D texturing technique using a 3D shaping liquid. This shaping remains embedded in the texturing layer and the 3D structure is revealed by material removal, in the present example of the 3D texturing liquid or of the mixture of 3D shaping liquid and the material of the texturing layer covered by the said 3D texturing liquid (4.7).

FIG. 5

FIG. 5 illustrates the decoration of a floor plank with the locking system. The adhesive is applied to the top surface and the surface of the bevel of the said plank. The transfer adheres where the adhesive is applied to the top surface and to the surface of the bevel of the plank. The combination of layers forming transfer decoration has a shape, a length and a width corresponding to the ones of the top surface of the plank and of the surface of the bevels of the plank.

FIG. 5A to 5C show different steps of the process for applying the said transfer décor to a plank.

FIG. 6

FIG. 6 illustrates the top view of a functional pattern for the escape of air during the application of the transfer to the plank:

FIG. 6A showing a pyramid pattern.

FIG. 6B showing a hemispherical/conical pattern.

FIG. 7

FIG. 7 illustrates the process for making and applying the transfer decoration according to the third alternative embodiment of the present invention with a temporary support which can be continuously reused. The layers are continuously produced and transferred on the material to be decorated. The texturing layer is three-dimensionally shaped by using a direct 3D texturing technique using a 3D shaping liquid. This shaping remains embedded in the texturing layer and the 3D structure is revealed by material removal, in the present example of the 3D texturing liquid or of the mixture of 3D shaping liquid and the material of the texturing layer covered by the said 3D texturing liquid (7.7).

### EXAMPLES

### Example 1

Use of continuous support.
A 3D structured shaping layer 2.1 with a thickness of 140μ was applied to a silicone membrane, with a thickness of 330×1200×3 mm (FIG. 2). The 3D shaping layer showing a three-dimensional structure representing the structure of a brushed wood. The silicon membrane being in the form of a continuously rotating closed transport belt having a predetermined dimension in the direction perpendicular to the advancing direction of the belt. The 3D structured shaping layer was created by means of inkjet printing in singlepass mode with a radiation-curable formulation designed to allow detachment from the silicone membrane. The structure was cured using a 395 nm UV LED lamp.
Subsequently, by means of a slot-die, a texturing layer 2.2 in the form of a protective layer of 200μ, was applied, consisting of a radiation-curable coating containing aluminum oxide to increase its anti-abrasive properties. The protective layer was then cured using a 395 nm UV LED lamp.
Subsequently, the image of the wood corresponding to its structure was printed by inkjet printing in single pass mode. This decorative layer 3.2 was then cured using a 395 nm UV LED lamp.
A white layer 4.2 was applied to the surface and bevel of a SPC (Stone Plastic Composite) plank consisting of a cross-linkable formulation. The application took place by means of a rolling machine in 2 passes of 20 g/m² each. The white layer 4.2 was then cured using a 395 nm UV LED lamp.
On the surface where the white layer 4.2 was applied, an adhesive layer 5.2 was applied by singlepass inkjet printing, 25 g/m², consisting of a light cross-linked PSA formulation which was then polymerized, using a 395 nm UV LED lamp, leaving the adhesive and receptive surface.
The support formed by the transport belt of silicone membrane was then turned and the transfer decoration consisting in the combination of the said 3D structured shaping layer 1.2, the texturing layer 2.2, the decorative layer 3.2 is applied by calender on the exposed surface of the adhesive SPC layer 5.2. The silicone membrane being pressed against the surface of the SPC making the transfer decoration adhere well to the surface and bevel.
The workpiece with the transfer decoration leaves the transportation belt and the silicone membrane forming it is separated from the said transfer decoration. The said silicone membrane remaining clean and the transfer decoration is applied perfectly to the surface of the SPC dashboard. The 3D structured shaping layer is still adhering onto the surface of the texturing layer formed by the protective coating.
Subsequently, as indicated al step 7.2 by brushing with metal brushes, the 3D structured shaping layer was removed, leaving a three-dimensionally surface of the the protective layer being the negative of the 3d structure of the shaping layer 1.2. Simultaneously with the use of TINEX brushes, less aggressive than those used previously, the abundance of the transfer has been removed which is facilitated by the fact that it is not adhesive.
Finally and optionally, a finishing layer 8.2 was applied by roller coatinging consisting of a radiation-curable formulation for flooring with gloss 8, polymerized with a Hg lamp.

The structure is well defined, with a maximum depth of 140μ.

Abrasion according to EN13229 corresponds to AC5.

### Example 2

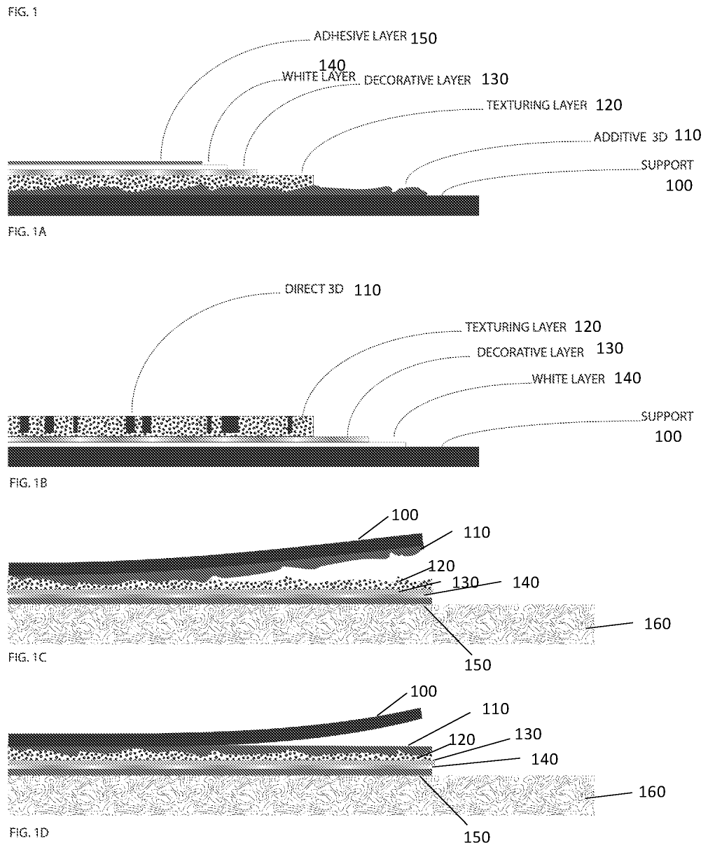

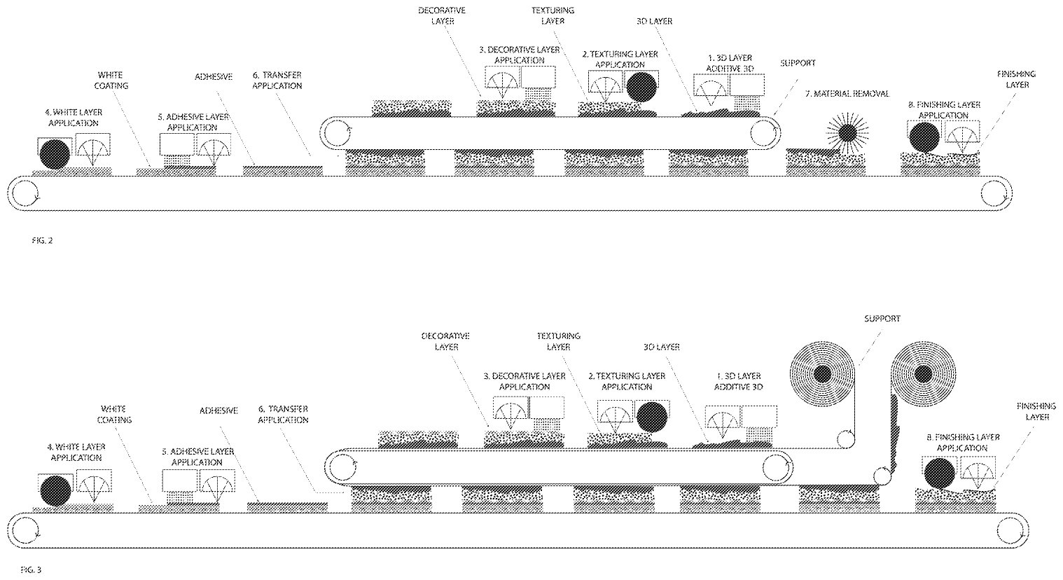

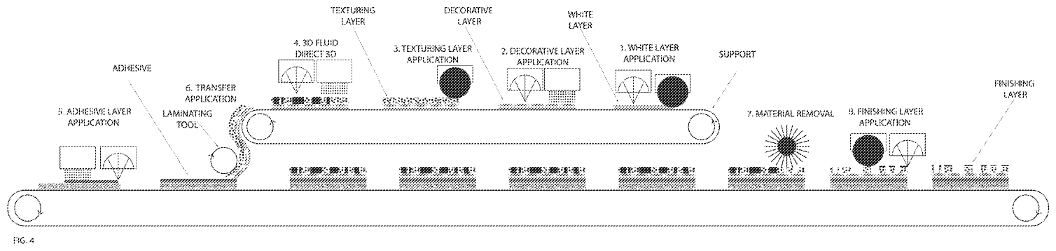

Use of Flexible Disposable Substrate.
A 3D structured shaping layer 1.3 with a thickness of 80μ was applied to the BOPP film, with dimensions of 14000×80×0.05 mm (FIG. 3), representing the structure of a brushed wood. The 3D structured shaping layer was created by means of single-pass inkjet printing with a radiation-curable formulation designed to guarantee adhesion to the support. The structure was cured using a 395 nm UV LED lamp.
Subsequently, a texturing layer 2.2 in the form of a protective layer, of 100μ, was applied by means of a slot-die, consisting of a radiation-curable coating containing aluminum oxide to increase its anti-abrasive properties. The protective layer was then cured using a 395 nm UV LED lamp.
Subsequently, the image of the wood corresponding to its structure was printed by inkjet printing in single pass mode. This decorative layer 3.2 was then cured using a 395 nm UV LED lamp.
Subsequently, an adhesive layer 4.3 consisting of a radiation-curable PSA was applied, 25 g/m² by singlepass inkjet printing, which was then polymerized by means of a 395 nm UV LED lamp.
The combination of layers formed by the flexible support, the 3D structured shaping layer 1.3, the texturing layer 2.3 and the decorative layer 3.3 are then applied by reversing and pressing against the exposed surface of the adhesive layer 5.3 provided on the plank. As in the previous example 1 a white layer 4.3 may be applied to the plank before applying the adhesive layer 5.3. The reversing and the pressing of the transfer decoration formed by the combination of the said flexible support, the 3D structured shaping layer 1.3, the texturing layer 2.3 and the decorative layer 3.3 is carried out by means of a transport belt provided at a certain distance above a transport belt feeding the plank. The distance from the two transport belts corresponds substantially to the total thickness of the transfer decoration together with the thickness of the plank with the white layer 4.3 and with the adhesive layer 5.3 reduced by a certain measure corresponding to a predetermined pressing action of the transfer decoration a against the plank with the white layer and the adhesion layer. At the end of the upper transportation belt, the flexible media and attached to it the 3d structured shaping layer are separated from the texturing layer which remains adhering together with the decorative layer to the plank in particular to the adhesion layer provided on top of the plank and of the surface of the upper bevel of the plank.
The surface of the profile appears decorated with the 3D structured texturing layer as the protective coating representing a brushed wood grain.

The structure is well defined, with a maximum depth of 80μ.

The support together with the 3D structured shaping layer is wound in a storing coil or the 3D structured shaping layer may be also separated from the support and the support alone is then stored in for of a coil.

As in the previous example 1, optionally, a finishing layer 8.2 was applied by roller coating consisting of a radiation-curable formulation for flooring with gloss 8, polymerized with a Hg lamp.

### Example 4

Generating of a transfer decor by means of a DIRECT 3D shaping technique of the texturing layer.

FIG. 4 shows a device for carrying out the textured coating of a plank which is mainly configured as in the previous examples referring to FIGS. 2 and 3.

In this example the difference resides in the fact that no 3d structured shaping layer is created which has the function of shaping three dimensionally the contact surface with the texturing layer.

Furthermore, the 3D structure is not already present on the transfer at the moment of application of the said transfer to the plank, but only later on at a removal step 7.4.

According to the present example on a transient support surface of a continuous transport belt a combination of layers are formed of which a first white layer 1.4 an which a decorative layer 2.4 is applied. In this embodiment the white layer is not applied to the plank and as it will be clear by the following is not provided between the plank and the adhesive layer as in the previous examples, but it is provided above the adhesive layer 5.4 which is applied directly onto the plank surface.

On the decorative layer 2.4 a further layer is applied. This layer is a texturing layer 3.4 which also here can be in the form of a protective layer as in the previous examples 1 and 3.

Onto the texturing layer 3.4 a 3D texturing liquid is applied preferably by inkjet printing as indicated by 4.4. This liquid may have different interactions with the texturing layer 3.4 and is applied when the said texturing layer is still liquid.

Examples of this technology are described with more details in the documents WO2020039361A1 and/or WO2021214659A1. UV irradiation alternatively or in combination with physical interactions and/or chemical reactions between the texturing layer 3.4 and the 3D texturing liquid 4.4 may provide for different physical and/or chemical features of the zones of the texturing layer 3.4 at which the 3D texturing liquid has been applied with respect of the zones of the texturing layer 3.4 at which no 3D texturing liquid has been applied. This allows to have a different response to removing means of the said zones of the texturing layer 3.4 at which the 3D texturing liquid has been applied with respect of the zones of the texturing layer 3.4 at which no 3D texturing liquid has been applied and thus to reveal a 3D structure made of recesses and reliefs of the surface of the texturing layer 3.4 by means of a removal tool related to the said different physical/chemical features.

In the example related to FIG. 4, the removal I carried out by brushing as indicated at step 7.4. Nevertheless, as it is disclosed in the above cited documents alternative means may also be possible such as water jets, air jects, washing, dilution, sanding and other tools and combinations of one or more of the said tools depending on the physical/chemical features differentiating the above specified zones one from the other. In the present example the case is illustrated in which after UV irradiation the zones at which the 3D texturing fluid was provide are less hard that the ones at which the texturing layer was uncovered by the fluid and directly exposed to the UV radiation, so that the 3D texturing fluid on and/or incorporated in the texturing layer is removed by mechanical brushing.

As a further difference regarding the example 3 in relation to examples 1 and 2, here the order of deposition of the layers forming the transfer decoration to be applied to the plank is the same one that the said layers should have when applied on the plank and is not inverted such as in the examples 1 and 2. Therefore in the present case no inversion of the combination of the layers forming the transfer decoration is necessary, but the combination of white layer 1.4, decorative layer 2.4, texturing layer 3.4 and 3D texturing fluid 4.4 is applied with the same order onto the adhesive layer on the plank as show at step 6.4.

A calender roll being used for pressing the transfer decoration onto the adhesive layer 5.4 on the plank.

Similarly, to the previous examples also in example 3, optionally, a finishing layer 8.2 was applied by roller coating consisting of a radiation-curable formulation for flooring with gloss 8, polymerized with a Hg lamp.

FIG. 1A shows the combination of layers forming a transfer decoration according to one embodiment of the invention relating to the first alternative. Here a variant is shown which provide that the white layer and the adhesive layer are applied both also to the transfer decoration and not to the plank.

The construction of the transfer layer is made on a support 100 on which a 3D structured shaping layer is additively applied, for example by inkjet printing as indicated by ADDITIVE 3D 110.

On the 3D structured shaping layer a texturing layer 120 is applied which conforms to the 3D structures surface of the shaping layer 110 being provided with its negative shape at the contact surface with the 3D structured shaping layer 110.

On the texturing layer 120 a decorative layer 130 may be provided which for example may reproduce the image of the color pattern of the wood while the 3D structure represents the texture corresponding to the said color pattern.

A white layer 140 is applied onto the decorative layer 130 which layer has the function of avoiding that the color of the plank or the workpiece to which the transfer decoration has to be applied will mix up with the colors of the decorative layer 130.

On the white layer 140 finally an adhesive layer 150 is applied.

Referring to further embodiments or variants FIGS. 1A to 1D, FIGS. 5a, 5b and 5c and 6a and 6b are described with more detail.

The features describe with reference to the said figures either correspond to features already disclosed in the previous examples or they refer to additional features which may be provided in any combination or sub-combination with the features of the above examples.

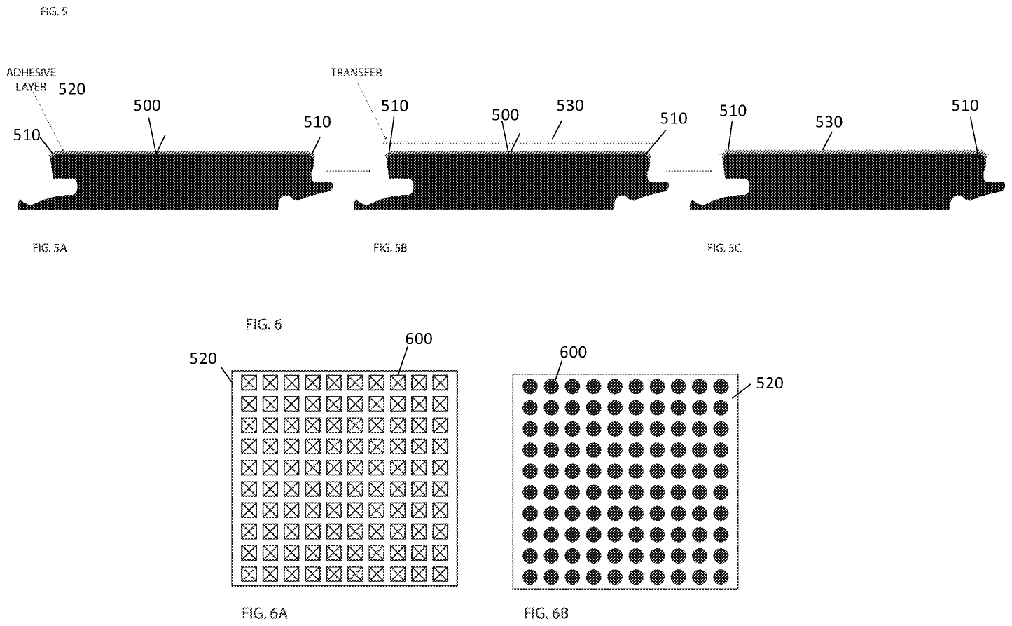

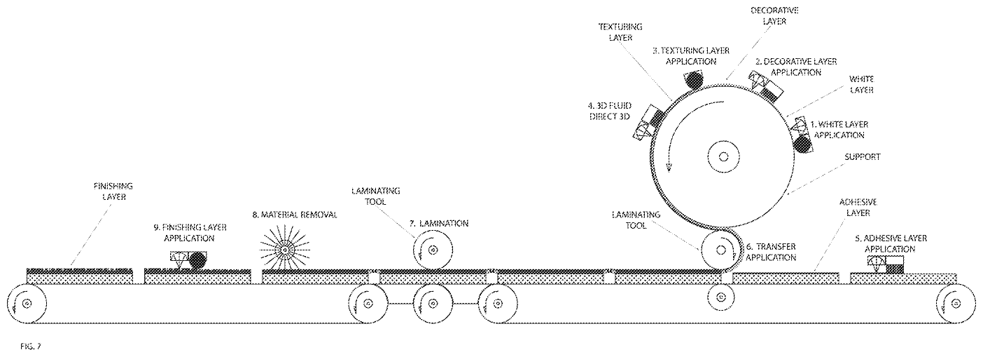

As illustrated in FIGS. 6a and 6b the adhesive layer may be applied using a pattern of distribution of the adhesive such that the air inclusion is avoided by allowing air escape. Two patterns are shown here a patter in which pyramidal spots are distributed over the contact surface and a pattern where spherical spots are distributed over the contact surface. The shapes of these spots being only examples and other shapes or combination of shapes as well as distributions may be provided.

FIG. 1C sows the transfer decoration according to FIG. 1 reversed and applied onto the surface of a workpiece 160.

FIG. 1c essentially shows the process according to example 2 in which the support 100 and the 3D structured shaping layer 110 are separated together from the texturing layer 120.

FIG. 1d shows essentially the situation of example 1 in which the support 100 separates from the 3D structures shaping layer 110 which remains adhering to the texturing layer 120 and has to be removed by a further removing step.

Coming to FIG. 1B the transfer decoration according to example 3 is shown with more detail. The transfer décor is provided on a substrate which is the transient substrate as the continuous transport belt of FIG. 3 the combination of the layers, white layer 140, decoration layer 130, texturing layer 120 and a 3d Texturing fluid 170 is illustrated on the transient support 100′ and will directly applied to an adhesion layer provided on the workpiece without reversing it bottom up.

The texturing technique for 3D shaping of the texturing layer 110 is here the one according to the above mentioned and described direct 3D shaping technique.

FIG. 5 shows a side view on the shorter side of a flooring plank of the so called click type. This plank has an upper surface exposed to the view when applied to a floor which surface is indicated as 500 and has a bevel along each of the two longitudinal edges indicated with 510. In FIG. 5A an adhesive layer 520 is applied to the exposed surface 500 and to the surfaces of the bevel of the plank.

FIG. 5B shows a transfer decoration produced according to one of the alternative embodiments of the present invention which is indicated with 530 and which has an extension parallel to the short side of the plank corresponding to the extension of the surface 500 and the one of both bevels and an extension in the longitudinal direction of the surface 500 and of the bevel 510 (a direction perpendicular to the shortest side of the plank and to the sheet of the drawing) corresponding to the extension of the plank in the said longitudinal direction of the surface 500.

The Transfer decoration is applied in register with the plank surface 500 and the bevel 510 and as shown in FIG. 5c the 3D structured coating of the plank covers entirely the exposed (upper surface 500 of the plank and the bevels.

According to FIGS. 6A and 6B at least one of the contact surfaces of the transfer decoration and of a layer already applied to the workpiece as the adhesion layer in the corresponding variant embodiments may be provided with a structured surface by applying the said layer and particularly the adhesive layer according to a pattern of distribution of spots 600. Different shaped of spots may be provided such as pyramidal spots in FIG. 6A or spherical spots in FIG. 6B also the distance between the spots and or the design of the distribution pattern may vary along the surface to which the pattern of spots is applied or be uniform like in the shown examples.

1. A Method providing a workpiece with a three-dimensionally textured surface coating at least on part of its surface and consisting in using a transferable decoration for providing the said coating the method comprising the following steps:
a) Creating a three-dimensional layer by inkjet printing on at least part of a support.
b) Applying one or more of the following layers on at least part of the support:
i) Release layer
ii) Texturing layer
iii) Decorative layer
iv) Functional layer
v) White layer
vi) Colored layer
vii) Adhesive layer
c) Applying the transferable decoration on at least part of a material to be decorated.
d) Removing the support.
e) Revealing the 3D texture.

2. The method for providing a workpiece with a three-dimensionally textured surface coating at least on part of its surface by using a transferable decoration, according to claim 1 and providing the following steps:
a) Creating a three-dimensionally structured shaping layer by inkjet printing on at least part of a support by
b) Applying one or more of the following additional layers on at least part of the shaping layer, the said layers being applied one on top of the other according to the following order:
i) Optionally a release layer
ii) A texturing layer, the said texturing layer being three-dimensionally shaped by the said three-dimensionally structured shaping layer showing a complementary surface structure in relation to the said three-dimensionally structured layer
iii) A Decorative layer
iv) Optionally a Functional layer
v) An adhesive layer
c) Applying the transferable decoration on at least part of a workpiece to be decorated, the said workpiece having an external surface and the said transferable decoration being applied by bringing the said transferable decoration with the said adhesive layer in contact with at least part of the surface of the said workpiece;
d) Removing the support with the three-dimensionally structured shaping layer and the optional release layer;
e) Revealing thereby the texturing layer which is provided with the said surface structure complementary in relation to the said three-dimensionally structured shaping layer;
f) Optionally recovering and storing the said support and/or the said three-dimensionally structured shaping layer.

3. The method for providing a workpiece with a three-dimensionally textured surface coating at least on part of its surface by using a transferable decoration according to claim 1, the method including:
a) Creating a three-dimensionally structured shaping layer by inkjet printing on a temporary carrying support, the temporary carrying support not being part of the transferable decoration at the time of application of the transfer decoration to the workpiece;
b) Applying one or more of the following layers on the said three-dimensionally structured shaping layer according to step a), the said layers being applied one on top of the other according to the following order:
i) Optionally a release layer
ii) A texturing layer, the said texturing layer being three-dimensionally shaped by the said three-dimensionally structured shaping layer showing a complementary surface structure in relation to the said three-dimensionally structured layer
iii) A Decorative layer
v) a Functional layer
vi) An adhesive layer
c) Applying the transferable decoration on at least part of a workpiece to be decorated, the said workpiece having an external surface and the said transferable decoration being applied by bringing the said transferable decoration with the said adhesive layer in contact with at least part of the surface of the said workpiece;
d) Removing the said three-dimensionally structured shaping layer and the optional release layer;
e) Revealing thereby the texturing layer which is provided with the said surface structure complementary in relation to the said three-dimensionally structured layer.

4. The method for providing a workpiece with a three-dimensionally textured surface coating at least on part of its surface by using a transferable decoration, according to claim 1 the method including:
a) Creating a three-dimensional structured shaping layer by applying one or more of the following layers on a temporary support the said layers being applied one on top of the other according to the following order:
i) A first white layer;
ii) Optionally a decorative layer;
iii) A texturing layer;
iv) A fluid for three-dimensionally shaping the texturing layer which is applied on top of the said texturing layer by covering first areas and leaving uncovered second areas according to a predetermined pattern reproducing the pattern of the three-dimensional structure of the three-dimensionally structured coating;
b) Applying an adhesive layer to the surface of a workpiece in the parts of the said surface at which the three-dimensionally textured coating has to be applied;
c) Applying the transferable decoration on the said parts of a workpiece to be decorated, by bringing the surface of the white layer opposite to the decorative layer and/or opposite to the texturing layer in contact with the exposed surface of the said adhesive layer.
d) Revealing the three-dimensional structure of the texturing layer by removing the fluid for the three-dimensional shaping at least at some of the areas covered by the said fluid or removing at least partly for a certain depth the material of the texturing layer at least at some of the areas of the texturing layer not covered by the said fluid.

5. The method of claim 1, wherein one or more layers are applied continuously or in discrete mode.

6. The method of claim 1, wherein the layers are applied in different order.

7. The method of claim 1 in which one or more of the layers forming the transfer decoration are applied several times.

8. The method of claim 1, in which the layers include radiation-curable systems.

9. The method of claim 1, in which one or more layers in addition to their main function as release and/or texturing and/or decorative and/or white and/or colored and/or functional layer possess adhesive properties.

10. The method of claim 1, wherein the texturing layer is a protective layer containing anti-abrasive particles.

11. The method of claim 1, wherein the adhesive is a PSA (Pressure Sensitive Adhesive).

12. The method of claim 1, wherein the PSA is of the dual-cure type.

13. The method of claim 1, wherein the colored layer is generated by applying two or more superimposed colors.

14. The method of claim 1, wherein the functional layer contains pearlescent and/or micalized and/or metallic pigments.

15. The method of claim 1, wherein the functional layer possesses conductive properties.

16. The method of claim 1, wherein a chemical reaction takes place between two or more layers in contact with each other.

17. The method of claim 1, wherein one or more of the layers is applied to the material to be decorated before applying the transferable decoration.

18. The method of claim 1, wherein the transferable decoration is applied simultaneously on several contiguous planes of the material to be decorated such as a main surface exposed to the sight and adjacent surfaces of a bevel.

19. The method of claim 1, wherein after applying the transfer to the surface to be decorated, the three-dimensional structure remains incorporated in and/or adhering to the texturing layer.

20. The method of claim 1, wherein the three-dimensional structure is removed from the texturing layer, leaving the negative of the same inside in the texturing layer.

21-25. (canceled)
